(19) United States
(12) Patent Application Publication
(10) Pub. No.: US 2016/0261753 A1
(43) Pub. Date: Sep. 8, 2016

(54) System and Method to provide automated telecom services order management

(71) Applicant: Adam Kleinberg, SanFrancisco, CA (US)

(72) Inventor: Adam Kleinberg, SanFrancisco, CA (US)

(21) Appl. No.: 14/641,415

(22) Filed: Mar. 8, 2015

(51) Int. Cl. H04M 15/00; H04W 4/24

(52) U.S. Cl. CPC H04M 15/52; H04W 4/24

(57) ABSTRACT

A system for providing automated subscription services order to billing management comprising, a computer system for performing data storage, retrieval and computation, an interface for accepting input data and displaying results, the computer system further including a data storage memory for storing and retrieving data, and a communications system operatively connected to the computer system for sending and receiving data from the computer system.

### CROSS-REFERENCE TO RELATED APPLICATION

This application claims the benefit of U.S. Provisional Patent Application No. 61/950120, entitled “Integrated automated system and method to order process and manage services” filed Mar. 9, 2014, which is incorporated herein by reference in its entirety.

### BACKGROUND OF THE INVENTION

1. Field of the Invention

The present disclosure relates to a system and method for providing automated telecom services order management.

The current invention is a system and method for providing automated subscription services order to billing management. In other words, a system that takes into account the complex reality of billing subscription services.

2. Description of the Related Art

Increases in the complexity of telecom services have created the market demand for more robust order management methods.

Past methods for sales management methods did not provide a vertical solution for supporting processes, workflows and activities that are involved in processing telecom service order management.

Thus there is a need for a solution which will provide a tool for providing prebuilt functionality which supports the processes, workflows, and activity sets involved in MACD services. The present invention automates the introduction and order processing for the full range of voice, data, IP and other services for communications service providers in one integrated environment. The present invention order management tool handles the entire ordering process, from negotiation through install base, tracking to completion. Order capture for all orders is reduced to a few simple, error-proof tasks with manual intervention if desired.

### SUMMARY OF INVENTION

The current invention is a system and method for or providing automated telecom services order management.

Thus there is a need for a solution which will provide a tool for handling the entire ordering process, from negotiation through install base, tracking to completion. Order capture for all orders is reduced to a few simple, error-proof tasks with manual intervention if desired. organizing how business tasks are to be distributed and organized between business units.

The current invention is a system and method for providing a utility to fully integrate ordering, CRM and all business and operational support systems. It provides a single, unified customer view across all front and back office systems, dramatically increasing provider efficiencies and cutting costs. Order Management can be pre-integrated with any third-party billing products. The present invention may be adapted to be implemented through third party business applications, such as Sales force™, for example to include standard functionality of such third party applications.

Advantage of the disclosed invention is that it provides a solution to combine the original phases of Customer Relationship Management, (CRM) to the ongoing and continuing role of subscription management completely within one platform.

Therefore in accordance with an embodiment of the present invention, there is provided a system and method for subscription billing for usage tracking, point of sale, leasing or the bundling of both services and products.

Additionally the system provides for quoting, bundling, ordering, rating, metering and payments.

It is therefore an object of the present invention to provide a system for providing automated subscription services order to billing management comprising, a computer system for performing data storage, retrieval and computation, an interface for accepting input data and displaying results, the computer system further including a data storage memory for storing and retrieving data, and a communications system operatively connected to the computer system for sending and receiving data from the computer system.

The current invention is a system and method for providing a utility to fully integrate ordering, CRM and all business and operational support systems. It provides a single, unified customer view across all front and back office systems, dramatically increasing provider efficiencies and cutting costs. Order Management can be pre-integrated with any third-party billing products. The present invention may be adapted to be implemented through third party business applications, such as Sales force™, for including standard functionality.

It is therefore an object of the present invention to provide a system for providing automated order management for telecom subscription services comprising a computer system for performing data storage, retrieval and computation, an interface for accepting input data and displaying results, the computer system further including a data storage memory for storing and retrieving data and correlating data according to certain predefined criteria, the computer system performing predefined computations based on the correlated data; and a communications system operatively connected to the computer system for outputting results of the computer system computations.

### BRIEF DESCRIPTION OF THE DRAWINGS

The above and other aspects, features and advantages of certain exemplary embodiments of the present invention will be more apparent from the following detailed description taken in conjunction with the accompanying drawings, in which:

FIG. 1 is a depiction of a typical computer and network system for use with the present invention.

FIG. 2 illustrates a system of an exemplary computer or device for use with the present invention.

FIG. 3A illustrates a block diagram and flowchart depicting various logical and functional components of the system and method according to the present invention.

FIG. 3B illustrates a block diagram and flowchart depicting various functional and user interface components of the system and method according to the present invention.

FIG. 4 illustrates an exemplary screen shot of a user interface depicting an exemplary task sequence of the system and method according to the present invention.

FIG. 5 illustrates an exemplary screen shot of a particular feature provided by a user interface of the system and method according to the present invention.

FIG. 6 illustrates alternate exemplary screen shot of an laternate feature provided by a user interface of the system and method according to the present invention.

### DETAILED DESCRIPTION OF EXEMPLARY EMBODIMENTS

Exemplary embodiments of the present invention will be described herein below with reference to the accompanying drawings to assist in a comprehensive understanding of exemplary embodiments of the invention as defined by the claims and their equivalents. In the following description, well-known functions or constructions are not described in detail since they would obscure the invention in unnecessary detail by a person of ordinary skill in the art with unnecessary detail of the well-known functions and structures.

Therefore, the terms used herein should be understood based on the descriptions made herein in view of the ordinary level of skill in the art. The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents. Although various specific details are included to help understanding of the present invention, they are regarded only as exemplary. Thus, those skilled in the art can variously change and modify the embodiments described herein without departing from the scope of the present invention. Further, a description of known functions and configurations will be omitted for clarity so as to not obscure the invention.

Hereinafter, a description will be given is a system and method for providing automated subscription services order to billing management according to one embodiment of the present invention.

The present invention discloses is a system and method for providing automated subscription services order to billing management. The present invention provides a system for populating in the memory of a computer system many different parameters related to the start to finish steps for ordering, provisioning and billing of a network communications system. Moreover, the system provides a way to utilize the system to automatically retrieve from the memory of the computer system all of the parameters for each of the steps related to ordering, provisioning and billing of a network communication system and automatically applying each of the parameters to implement each of parameters to automatically set up the network communications system. For example: The software application of the present invention can retrieve from the computer system memory parameters regarding the number of telephone numbers to assign to a particular customer and then based on the retrieve information, automatically configure the network communication system. In other works, once a user has saved a database into the memory of a computer all of the parameters related to a particular network communications system, such as, for example a telephone system, the user may then use the system according to the present invention to apply the saved parameters to the network communication system to automatically perform the set-up steps of the network communications system. Thus the network communications system would be pre configured to access the network to provide communications. For example the number and switching information for telephone lines would be configured into the network communication system and the network communication system software files would be modified by the software application of the present invention to provide network communications by retrieving from memory the required network settings, parameters and information and then modifying the system memory of the network communication system such that it is configured to provide network communications. In this way the software code of the present invention can modify the network communications system by access the memory locations where the relevant settings parameters and information i stored and applying those settings to the network system. Therefore, the network communications system will be enabled to provide communications in addition to providing the user with an automated system for synchronizing all administrative tasks with the particular communications account that has been configured such as record keeping related to custom provisioning parameters and billing. For example a custom provisioning of a plurality of telephone lines would record the number of lines and the switching information such as telephone numbers and then provide to the billing aspect of the present invention the required information to issue bills for the custom installation. Thus, the present invention provides a way of entering and saving in the memory of a computer parameters of a network communications system and then synchronizing that information by accessing the memory locations storing the parameters and applying the information to the communications system to configure the communication system with the proper settings not only for operation but also to allow the user to monitor the administrative aspects of the communications system such as user information and billing. The network communications system can then access the memory location having all the related settings, parameters and information to provide communications. in that way the present invention can provide a way for the network communications system to access the memory locations that contain the appropriate settings, parameters and information and simultaneously provide that information to the communications system to automatically configure communications. Some of the settings, parameters and information could include in one exemplary application of the present invention: the number of telephone lines, the switching information such as telephone numbers the order information, the account information such as owner and billing and payment information related to the provisioning of the communications network. For example, in one embodiment of the present invention a telephone company could implement the present invention to provide a system for the ordering of phone service, an automatic provisioning system and a billing system. The present invention would provide a way to not only record in a database the order information, but would also automate the provisioning process by applying the appropriate settings to the communications system to provide the number of telephone lines a customer requested but also include the switching information such as the phone numbers for each line, in this way the present invention can provide a way to automatically and simultaneously record in a computer memory administrative and technical data related to a communication network and also provides a way to automatically apply the data to the network communications system. Because many network communication systems are now setup and configured solely in a software environment, the present invention provides a tool for changing the network communications system configuration for a particular users needs and saving into memory the changed configuration as well as the information required to implement the changed configuration so that the network communications system can access the required data on an as needed basis, for example when a configuration is changed or if a user needs further customization.

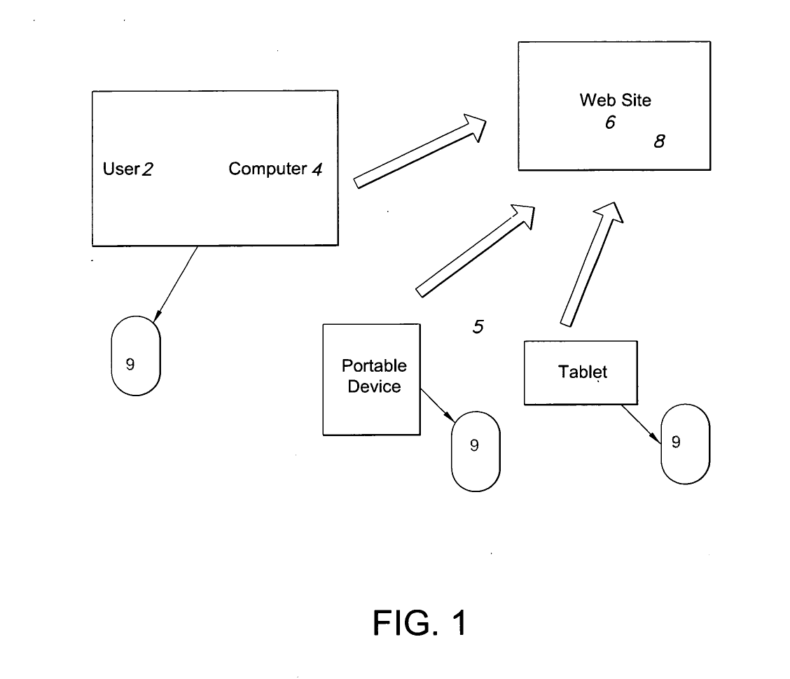

As shown generally by FIG. 1, a user 2 of a computer 4 or handheld device 5 accesses an Internet website 6 for posting content 8. Those of skill in the art would recognize that the computer 4 or hand held device 5 each has a processor and a memory coupled with the processor where the memory is configured to provide the processor with executable instructions. Each of the computer 4 or hand held devices 5 have a drive or access to a drive, represented by 9. It should also be noted that as used herein, the term handheld device includes phones, smart phones, tablets, personal digital assistants, media and game players and the like.

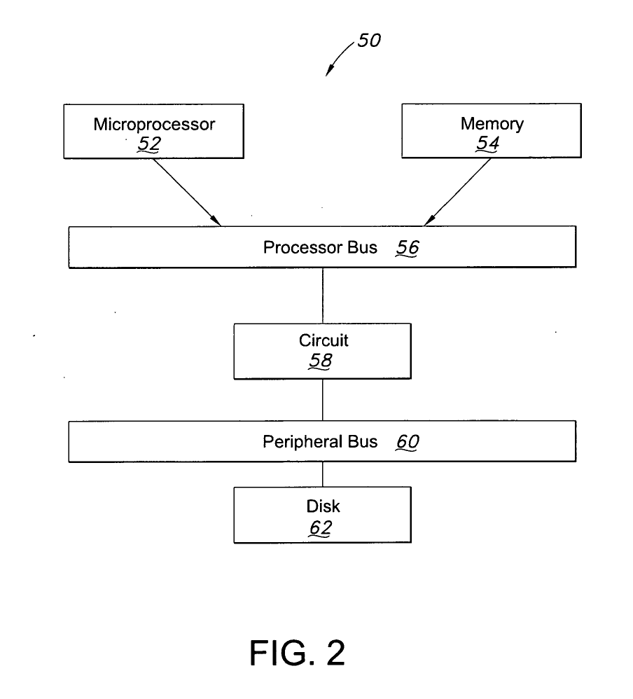

FIG. 2 illustrates a system 50 of a computer or device which includes a microprocessor 52 and a memory 54 which are coupled to a processor bus 56 which is coupled to a peripheral bus 60 by circuitry 58. The bus 60 is communicatively coupled to a disk 62. It should be understood that any number of additional peripheral devices are communicatively coupled to the peripheral bus 60 in embodiments of the invention. Further, the processor bus 56, the circuitry 58 and the peripheral bus 60 compose a bus system for computing system 50 in various embodiments of the invention. The microprocessor 52 starts disk access commands to access the disk 62. Commands are passed through the processor bus 56 via the circuitry 58 to the peripheral bus 60 which initiates the disk access commands to the disk 62. In various embodiments of the invention, the present system intercepts the disk access commands which are to be passed to the hard disk.

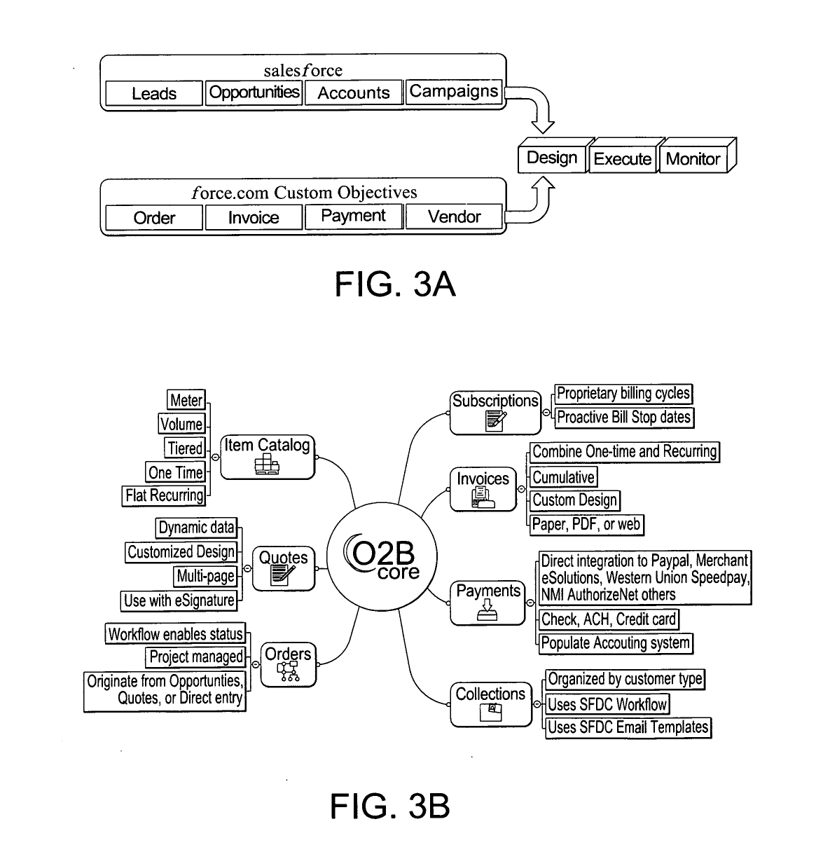

FIGS. 3A and 3B illustrate a block diagram depicting various components of the business management computer program for the system and method according to the present invention in two different variations, although representing similar user interface components. There is shown the various functional component systems and methods, including: standard objects such as Leads, Opportunities, Accounts, Campaigns, and custom objects such as Order, Invoice, Payment and Vendor; as well as functional capacities such as Design, Execute and Monitor. Although the categories and components are not so limited and may be modified as needed.

The present invention may be implemented on a subscription software work task organization and execution software platform such as for example the Sales force™ platform. However, the present invention is not so limited and may be implemented on similar computer programs that provide a graphical user interface for organizing and managing sales, bookkeeping and billing tasks.

Moreover the present invention provides a subscription billing system that provides; A tool to define the business processes in a highly graphical manner, design, assign, and organize Subscription software program Tasks on any standard or custom object. Parallel tasking, priority based task dependency checking. Tasks are created and assigned when required, not at bulk loaded onto a user's desk. Process flow can be applied to any standard object in the subscription software platform (i.e. Opportunity or Case) or any custom object. Graphical monitoring tool which shows all the tasks in the system by the Objects, a complete task dashboard.

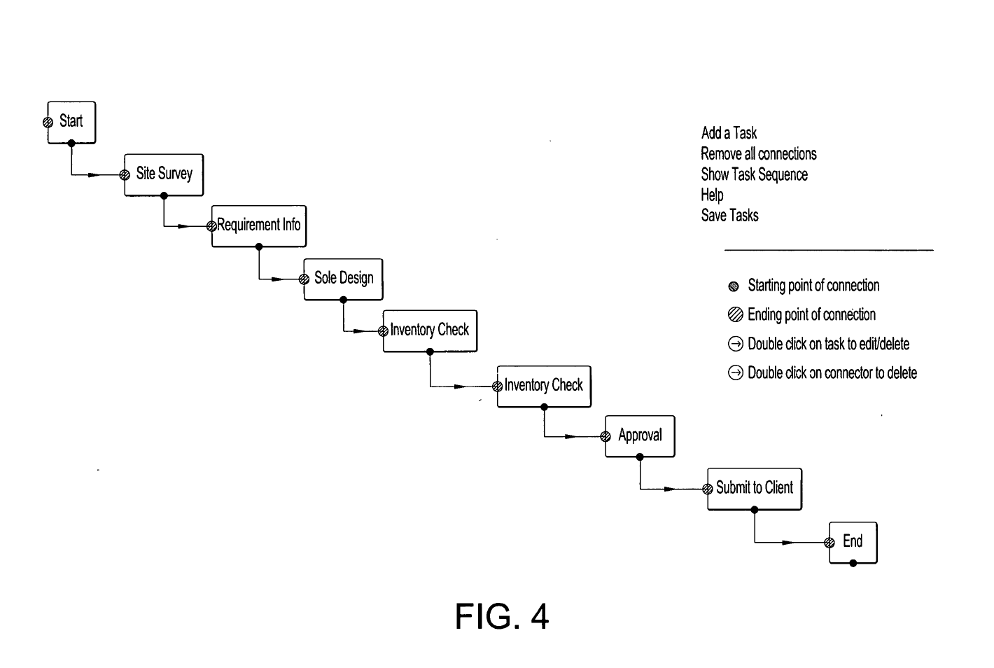

FIG. 4 depicts a screenshot of an exemplary task sequence canvas in accordance with the present invention depicting exemplary tasks such as: Site Survey, Requirement Info, Solution Design, Inventory Check, Create Proposal, Approval and Submit to Client. Additionally control and task manipulation commands are shown such as Add a Task, Remove all connections, Help and Save Tasks, as well as other commands for customizing the user interface, those include commands to create a task sequence. Although all such depictions are exemplary and not intended to limit the present invention.

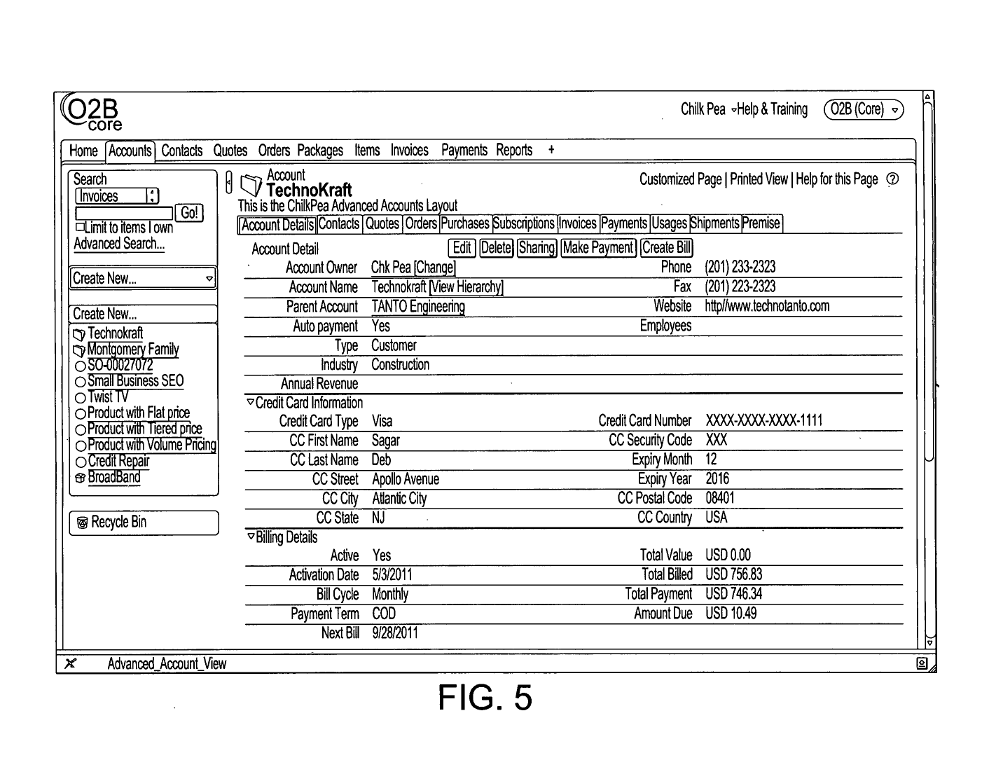

FIG. 5 depicts an exemplary Due Date Tasks Report, which may be available to the user of the present invention. The report may be viewed for Task Detail, Work Order, or Quote by selecting the appropriate tab, and includes expandable menus for Owner Task report and Due Date Task Report, although additional reports are contemplated within the scope of the present invention. Finally there may be included a Work Order Task Table for displaying Work Order information such as: Assigned to, Due Date, Priority, Name, Status, and Subject.

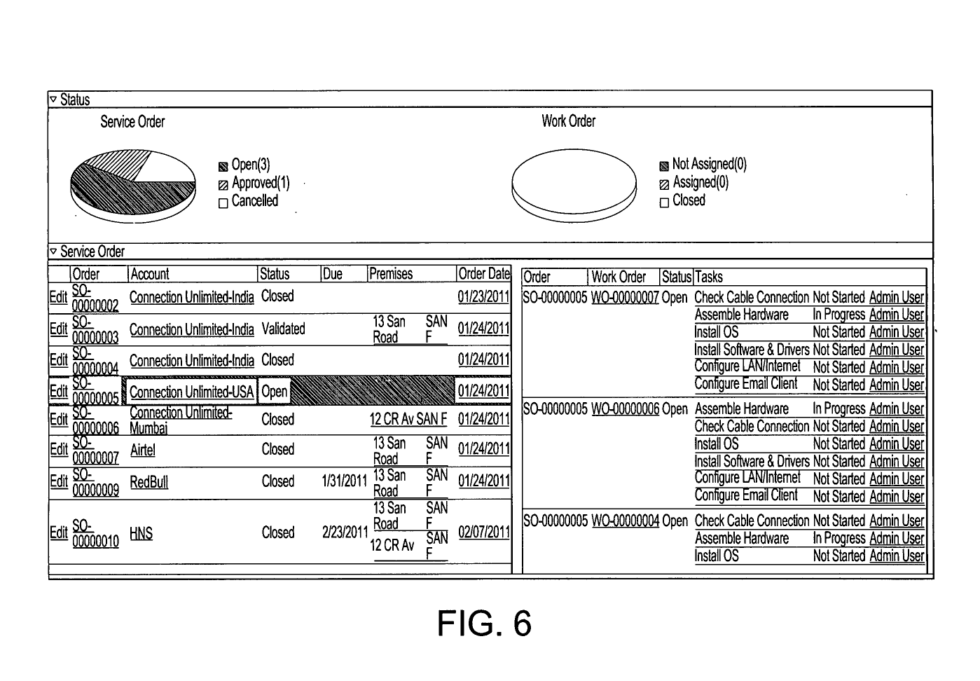

FIG. 6 depicts an alternate user interface of the current invention for tracking various aspects of a service order including orders, tasks dates, work order, status and other exemplary aspects of a service order

The invention is not restricted to the details of the foregoing embodiments. The invention extend to any novel one, or any novel combination, of the features disclosed in this specification (including any accompanying claims, abstract and drawings), or to any novel one, or any novel combination, of the steps of any method or process so disclosed.

The methods according to claims of the present invention and/or embodiments described in the specification of the present invention may be implemented as hardware, software, or combinational type of the hardware and the software.

When the method is implemented by the software, a computer-readable storage medium for storing one or more programs (software modules) may be provided. The one or more programs stored in the computer-readable storage medium are configured for being executed by one or more processors in a portable electronic device. The one or more programs include instructions for allowing the portable electronic device 100 to execute the methods according to the claims of the present invention and/or the embodiments described in the specification of the present invention.

These programs (software module, software) may be stored in a RAM, a non-volatile memory including a flash memory, a ROM, an EEPROM, a magnetic disc storage device, a CD-ROM, a DVD or an optical storage device of a different type, and a magnetic cassette. Or, the programs may be stored in a memory configured by combination of some or all of them. Also, the configured memory may include a plurality of memories.

Also, the programs may be stored in an attachable storage device capable of accessing an electronic device through each of communication networks such as the Internet, an intranet, a Local Area Network (LAN), a Wide LAN (WLAN), and a Storage Area Network (SAN) or a communication network configured by combination of them. This storage device may connect to the electronic device through an external port.

Also, a separate storage device on a communication network may connect to a portable electronic device.

While the present invention has been particularly shown and described with reference to exemplary embodiments thereof, it will be understood by those skilled in the art that various changes in form and details may be made therein without departing from the spirit and scope of the present invention as defined by the appended claims and their equivalents. Therefore, the scope of the present invention should not be limited to the above-described embodiments but should be determined by not only the appended claims but also the equivalents thereof Specifically, it should be noted that the movement intervals, drag angles, directions and movement interval units described herein are merely exemplary and may be varied in accordance with the spirit and scope of this invention.

1. A system for creating an electronic connection for providing a network communication service comprising:
Providing a computer system for performing data storage, data retrieval and computation tasks,
Said computer system also having an interface for accepting input data and displaying results,
The computer system further including a nonvolatile data storage memory for storing and retrieving data,
Providing a computer communications system operatively connected to the computer system for sending and receiving data from the computer system, a network communications system having a software application for providing said network communications service and a system memory,
Storing in said non-volatile computer memory the network settings, parameters and information required for ordering, provisioning and billing of said network communications service, connecting to said network communication system;
Configuring the network communications system to provide communications by retrieving from said non-volatile memory the required network settings,
parameters and information,
Modifying the system memory of the network communication system such that it is configured to provide network communications, and
Generating billing information for said network communications service.

2. A system for provisioning a telecom service connection and providing a data management record of said telecom services connection comprising:
A computer system having a nonvolatile data storage memory for storing and retrieving data, for performing data storage, data retrieval and computation tasks, said nonvolatile data storage memory including settings, parameters and information required for ordering, provisioning and billing of said network communications service
A computer communications system operatively connected to said computer system for sending and receiving data from said computer system,
A network communications system having a software application for providing said telecom services connection and a memory location for storing relevant settings parameters and information for providing said telecom services, and
Said computer system further having a software code to modify said the memory location where the relevant settings parameters and information is stored.

3. A system for provisioning a telecom service connection and providing a data management record of said telecom services connection as set forth in claim 2 wherein said management record includes order information.
